(19) United States
(12) Patent Application Publication
(10) Pub. No.: US 2022/0328245 A1
(43) Pub. Date: Oct. 13, 2022

(54) R-Fe-B SINTERED MAGNET AND GRAIN BOUNDARY DIFFUSION TREATMENT METHOD THEREOF

(71) Applicants: Xiamen Tungsten Co., Ltd., Xiamen, Fujian (CN); Fujian Changting Golden Dragon Rare-Earth Co., Ltd., Changting, Fujian Province (CN)

(72) Inventors: Dawei SHI, Xiamen, Fujian (CN); Kexiang ZHONG, Changting, Fujian Province (CN); Maolin WU, Xiamen, Fujian (CN)

(21) Appl. No.: 17/626,954

(22) PCT Filed: Jan. 20, 2021
(86) PCT No.: PCT/CN2021/072896

§ 371 Date: Jan. 13, 2022

(30) Foreign Application Priority Data
Jan. 21, 2020 (CN) 202010070960.0

(51) Int. Cl. H01F 41/02; H01F 1/057

(52) U.S. Cl. CPC H01F 41/0293; H01F 1/0577; H01F 1/0573

(57) ABSTRACT

Disclosed in the present invention is an R—Fe—B sintered magnet and grain boundary diffusion treatment method. The R—Fe—B sintered magnet is obtained by performing HR grain boundary diffusion treatment on an R—Fe—B sintered green body, wherein the green body at least comprises 28 wt %-33 wt % of R, which is at least one rare earth element including Nd; 0.83 wt %-0.96 wt % of B; and 0.3 wt %-1.2 wt % of M. A grain boundary diffusion direction is perpendicular to a magnetization direction, and in the diffusion direction, the ratio of HR contents of any two points spaced from the diffusion plane by a distance of no more than 500 μm is 0.1-1.0. Grain boundary diffusion of a diffusion source is performed in a direction perpendicular to c axis, so that local demagnetization is efficiently controlled, a diffusion effect is enhanced, a manufacturing procedure is simplified, and deformation factors are eliminated.

### TECHNICAL FIELD

The present invention relates to the technical field of rare earth permanent magnet materials, and in particular to an R—Fe—B sintered magnet and a grain boundary diffusion treatment method thereof.

### BACKGROUND

Since the discovery of neodymium-iron-boron sintered magnets by American and Japanese scientists in the 1980s, due to their advantages of high magnetic energy product, high remanence, and the like, these magnets have been widely applied in aspects such as motors, electro-acoustic devices, computer hard disk drivers (HDD), military equipment, human magnetic resonance imaging instrument (MRI), microwave communication technologies, controllers, and instruments.

In recent years, as the demand for high-performance neodymium-iron-boron magnets has increased, grain boundary diffusion treatment technology has started to receive the enthusiasm and continued attention of related researchers. The grain boundary diffusion treatment technology is a technology in which heavy rare earth is attached to the surface of a neodymium-iron-boron magnet, and diffused and infiltrated into the magnet by a high-temperature treatment process. Compared with the conventional technology, this technology can use a small amount of heavy rare earth to greatly increase the coercivity of the magnet while keeping the remanence almost unchanged.

Although the improving effect of the grain boundary diffusion treatment on the performance of the final magnet is quite significant, it has its own limitations. H. Nakamura, et al. (“Coercivity distributions in R—Fe—B sintered magnets produced by the grain boundary diffusion process,” J. Phys, D: Appl. Phys. 2011, 44(6): 540) found that, in a case where a surface of a magnet with a thickness of 14.5 mm was coated with different amounts of a TbF₃ mixed solution and samples were cut at different depths to test the magnetic performance, when the depth was close to about 4 mm, the coercivity of the magnet after the diffusion treatment almost dropped to the level before the diffusion treatment, i.e., the diffusion depth of heavy rare earth elements in the magnet was limited. Niu E, et al. (“Anisotropy of grain boundary diffusion in sintered Nd—Fe—B magnet,” Applied Physics Letters, 2014, 104(26)) found that, the infiltration effect of grain boundary diffusion is anisotropic in orientation and non-orientation directions. In that study, dysprosium alloy powder was coated respectively on the entire surface of the sample, the end surface of the sample in the orientation direction, and the lateral surface of the sample to perform diffusion and comparison. It was found that the squareness of the magnet after diffusion varied with different diffusion directions, and the diffusion effect in the orientation direction was significantly better than that in the non-orientation direction.

In patent CN101939804A, researchers ignored the feature of the anisotropy of grain boundary diffusion, and the grain boundary diffusion depth and core-shell structure formation in the non-orientation direction perpendicular to the magnetization direction were poor, and there was no practical effect for most materials.

### SUMMARY

In view of the above situation, provided in the present invention is an R—Fe—B sintered magnet on which HR grain boundary diffusion treatment is performed. The sintered magnet is made by HR grain boundary diffusion in a direction perpendicular to the magnetization direction, which leads to convenience in processing, elimination of deformation factors, and precise controllability of the dimension, thereby greatly increasing material utilization.

In order to achieve the above purposes, the present invention adopts the following technical solutions:

an R—Fe—B sintered magnet, wherein the R—Fe—B sintered magnet is obtained by performing HR grain boundary diffusion treatment on an R—Fe—B sintered green body comprising an R₂Fe₁₄B-type main phase and comprising at least the following ingredients:

28 wt %-33 wt % of R, which is at least one rare earth element comprising Nd;

0.83 wt %-0.96 wt % of B;

0.3 wt %-1.2 wt % of M, which is selected from at least one of Al, Cu, Ga, Bi, Sn, Pb, and In;

and 65.2 wt %-70.5 wt % Fe, or Fe and Co; particularly, wherein the Fe content can reach 65.2 wt %-70.5 wt %, or alternatively, the two elements of Fe and Co can be replaced with each other and the sum of contents thereof can reach 65.2 wt %-70.5 wt %;

the HR is selected from at least one of Dy, Tb, Ho, Er, Tm, Y, Yb, Lu, and Gd;

the R—Fe—B sintered green body has a magnetization direction and several surfaces, wherein a surface perpendicular to the magnetization direction is an orientation plane, and a surface other than the orientation plane is a non-orientation plane; and an HR-containing diffusion source is applied to at least one non-orientation plane of the R—Fe—B sintered green body so that the grain boundary diffusion of HR is performed in a direction perpendicular to the magnetization direction of the R—Fe—B sintered green body, and the non-orientation plane to which the HR-containing diffusion source is applied is a diffusion plane; and

in a diffusion direction, a point has an HR content that increases with a smaller distance from the diffusion plane, and a ratio of HR contents of any two points spaced from the diffusion plane by a distance of no more than 500 μm is 0.1-1.0. In the calculation of the ratio of the HR contents of any two points here, the HR content of one of the two points spaced by a smaller distance from the diffusion plane is used as the denominator of the ratio.

On the basis of the above technical solutions, further, in the diffusion direction, the ratio of HR contents of any two points spaced from the diffusion plane by a distance of no more than 500 μm is 0.2-1.0.

On the basis of the above technical solutions, further, in the magnetization direction, the ratio of HR contents of any two points is 0.7-1.0, and preferably equal to or close to 1.0.

On the basis of the above technical solutions, further, the R—Fe—B sintered green body further comprises 0.05 wt %-2.5 wt % of T, which is selected from at least one of the following elements: Zn, Si, Ti, V, Cr, Mn, Ni, Ge, Zr, Nb, Mo, Pd, Ag, Cd, Sb, Hf, Ta, W, O, C, N, S, F, and P.

On the basis of the above technical solutions, further, the M is selected from at least one of Ga, Al, and Cu, and a sum of contents of the Ga, Al, and Cu is 0.3 wt %-0.8 wt %.

On the basis of the above technical solutions, further, the HR-containing diffusion source of the HR grain boundary diffusion is at least one of HR metal, HR oxides, HR hydrogen fluorides, HR fluorides, HR hydrides, HR oxyfluorides, or HR-M alloy.

On the basis of the above technical solutions, further, the HR-containing diffusion source is an HR-M alloy, wherein a content of M is 2 wt % or more and 30 wt % or less, and a content of the HR is 70 wt % or more and 98 wt % or less. Here, M is also selected from at least one of Al, Cu, Ga, Bi, Sn, Pb, and In.

On the basis of the above technical solutions, further, the R—Fe—B sintered green body is a square green body.

Further disclosed in the present invention is an HR grain boundary diffusion treatment method of the R—Fe—B sintered magnet, wherein the R—Fe—B sintered green body comprises a magnetization direction and several surfaces, wherein a surface perpendicular to the magnetization direction is an orientation plane, and a surface other than the orientation plane is a non-orientation plane; and an HR-containing diffusion source is applied to at least one non-orientation plane of the R—Fe—B sintered green body so that grain boundary diffusion of HR is performed in a direction perpendicular to the magnetization direction of the R—Fe—B sintered green body, and then heat treatment is performed.

On the basis of the above technical solutions, further, the R—Fe—B sintered green body is a square green body, and the HR-containing diffusion source is applied to four non-orientation surfaces of the R—Fe—B sintered green body.

On the basis of the above technical solutions, further, the preparation of the R—Fe—B sintered green body comprises at least the following steps: a process of melting raw material ingredients of the R—Fe—B sintered green body to obtain a rapid-quenched alloy; a process of performing hydrogen decrepitation and pulverization on the rapid-quenched alloy to obtain fine powder; and obtaining the R—Fe—B sintered green body, which is a square magnet, by magnetic field compacting and sintering of the fine powder, and applying the HR-containing diffusion source to four orientation surfaces of the R—Fe—B sintered green body.

The wt % mentioned in the present invention is a weight percentage.

The numerical range disclosed in the present invention comprises all point values in this range.

### BRIEF DESCRIPTION OF THE DRAWINGS

In order to explain technical solutions in the embodiments of the present invention or in the prior art more clearly, the drawings that need to be used in the description of the embodiments or the prior art will be briefly introduced below. Obviously, the drawings in the following description are only embodiments of the present invention. For those of ordinary skill in the art, other drawings can be obtained according to the provided drawings without inventive work.

FIG. 1 is a schematic plan view of a surface of a square green body perpendicular to the magnetization direction, and the arrows indicate diffusion directions;

FIG. 2 is a schematic plan view of an R—Fe—B sintered magnet;

FIG. 3 is another schematic plan view of an R—Fe—B sintered magnet;

FIG. 4 is a schematic plan view of a diffusion plane;

FIG. 5 shows comparison of distribution of the HR (Tb) element diffused in a direction perpendicular to the magnetization direction near the surface of the sintered magnet;

FIG. 5(a) is a conventional sintered magnet, and FIG. 5(b) is a sintered magnet of embodiment 1 of the present invention; and

FIG. 6 shows electron probe micro-analyzer (EPMA) characterization results of HR distribution of the sintered magnet in embodiment 1.1 of the present invention.

### DETAILED DESCRIPTION

In order to make the above purposes, features, and advantages of the present invention more obvious and understandable, the present invention will be further described in detail below in conjunction with particular implementations, but the protection scope of the present invention is not limited to the following embodiments. Experimental methods without particular conditions noted in the following embodiments usually follow the conventional conditions.

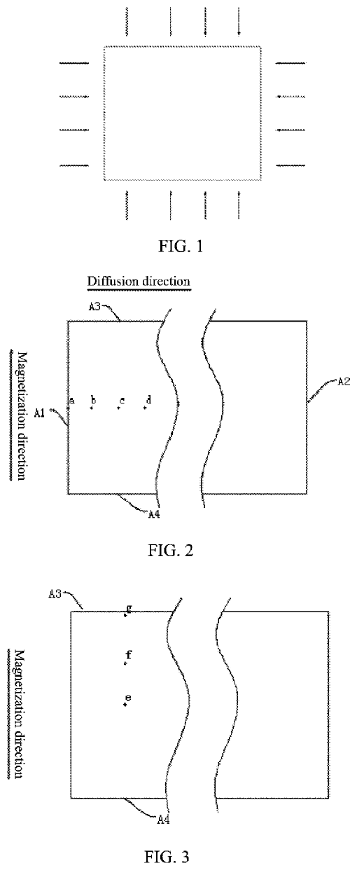

The diffusion direction mentioned herein: when the diffusion source is attached to one surface of the R—Fe—B sintered magnet by means of coating, vapor deposition, and the like, the direction perpendicular to the surface and toward the sintered center is the diffusion direction. As shown in FIG. 1, the R—Fe—B sintered green body is a square green body, and the HR-containing diffusion source is applied to four non-orientation surfaces of the R—Fe—B sintered green body, and the directions indicated by the arrows are the diffusion directions.

The magnetic performance evaluation process, ingredient measurement, and measurement of the temperature coefficient of coercivity mentioned herein are defined as follows.

Evaluation process for magnetic performance: the magnetic properties of a sintered magnet were tested using a NIM-200C measurement system from National Institute of Metrology of China.

Ingredient measurement: each ingredient is measured using high-frequency inductively coupled plasma optical emission spectroscopy (ICP-OES).

The oxygen content is measured by a gas analyzer based on the gas dissolution-infrared absorption method.

Temperature coefficient of coercivity (20° C.-60° C.): β=ΔH/ΔT×100%, unit: %/° C.

The detection limit of FE-EPMA (field emission electron probe microanalysis) detection is about 100 ppm, and the maximum resolution of FE-EPMA equipment is 3 nm.

Measurement of the HR content of the “point” in the sintered magnet: FE-EPMA acts on the specific region of the surface or the cut surface where the “point” is located to analyze the HR content, which is the HR content of the “point,” in the measurement region. The surface or cut surface where the “point” is located is a plane or cut surface perpendicular to the diffusion directions. The specific region refers to a square region with a length of 50 μm and the “point” is the midpoint of the square region.

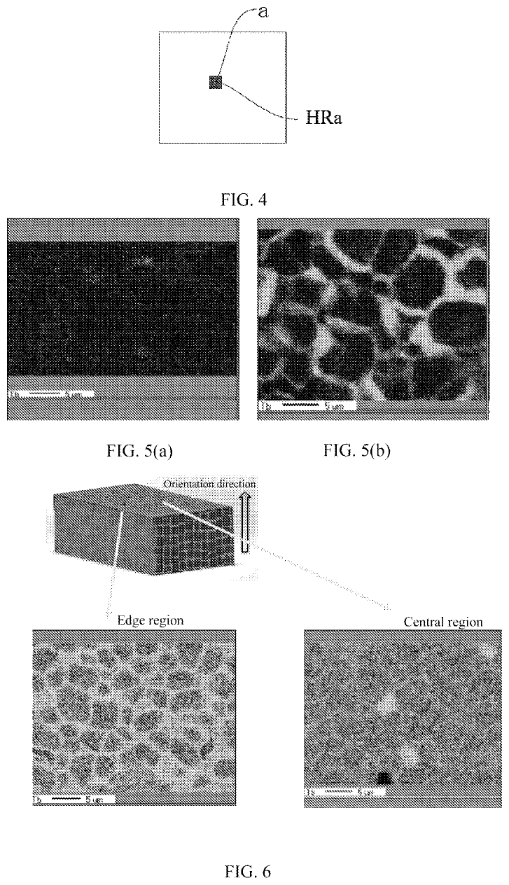

Selection of measurement points: the sintered green body is a cuboid with 6 surfaces. As shown in FIG. 2, A3 and A4 are orientation planes perpendicular to the magnetization direction, and A1 and A2 are non-orientation planes parallel to the magnetization direction. Surface A1 is coated with a diffusion source and heat-treated so that HR is diffused in a direction parallel to A3. Point a is any point on surface A1, point d is a point with a distance of 500 μm from the surface A1, and a line connecting points a with d is parallel to the diffusion directions. Positions at ⅓ and ⅔ of the line connecting points a with d are marked as points b and c. FIG. 3 is a plane parallel to the diffusion plane. Point e has a distance of 100 μm from the diffusion plane A1 and is located in a middle position of the magnetization direction. In the magnetization direction, point g has a distance of 100 μm from the orientation plane A3, and point f is located at the midpoint between points e and g. As shown in FIG. 4, the shaded portion in the figure is a square with a length of 50 μm, the midpoint of the square is point a, and the HR content in the square region is measured as HRₐ.

An R—Fe—B sintered magnet, wherein the R—Fe—B sintered magnet is obtained by performing HR grain boundary diffusion treatment on an R—Fe—B sintered green body comprising an R₂Fe₁₄B-type main phase and comprising at least the following ingredients:

28 wt %-33 wt %, and particularly 28 wt %, 29 wt %, 30 wt %, 31 wt %, 32 wt % or 33 wt %, of R, which is at least one rare earth element including Nd;

0.83 wt %-0.96 wt %, and particularly 0.83 wt %, 0.88 wt %, 0.90 wt %, 0.92 wt %, 0.94 wt % or 0.96 wt %, of B;

0.3 wt %-1.2 wt %, and particularly 0.3 wt %, 0.5 wt %, 0.7 wt %, 0.8 wt %, 0.9 wt %, 1.0 wt %, or 1.2 wt %, of M, which is selected from at least one of Al, Cu, Ga, Bi, Sn, Pb, and In;

and 65.2 wt %-70.5 wt % Fe, or Fe and Co; particularly, wherein the Fe content can reach 65.2 wt %-70.5 wt %, or alternatively, the two elements of Fe and Co can be replaced with each other and the sum of contents thereof can reach 65.2 wt %-70.5 wt %;

the HR is selected from at least one of Dy, Tb, Ho, Er, Tm, Y, Yb, Lu, and Gd;

the R—Fe—B sintered green body has a magnetization direction and several surfaces, wherein a surface perpendicular to the magnetization direction is an orientation plane, and a surface other than the orientation plane is a non-orientation plane; and an HR-containing diffusion source is applied to at least one non-orientation plane of the R—Fe—B sintered green body so that grain boundary diffusion of HR is performed in a direction perpendicular to the magnetization direction of the R—Fe—B sintered green body, and the non-orientation plane to which the diffusion source is applied is a diffusion plane; and

in the diffusion direction, a point has an HR content that increases with a smaller distance from the diffusion plane, and the ratio of HR contents of any two points spaced from the diffusion plane by a distance of no more than 500 μm is 0.1-1.0, particularly 0.1, 0.2, 0.3, 0.4, 0.5, 0.6, 0.7, 0.8, 0.9 or 1.0. When the two points almost overlap each other, the ratio is 1.0. In the calculation of the ratio of the HR contents of any two points here, the HR content of one of the two points spaced by a smaller distance from the diffusion plane is used as the denominator of the ratio. As for any two points, it is required that the line connecting the two points is parallel to the diffusion direction.

On the basis of the above technical solutions, further, in the magnetization direction, the ratio of HR contents of any two points is 0.7-1.0, and equal to or close to 1.0. This is due to the diffusion competition between the magnetization direction and the direction perpendicular to the magnetization direction inside the magnet, and the distribution of HR content has small fluctuations.

On the basis of the above technical solutions, further, the sintered magnet further comprises 0.05 wt %-2.5 wt % of T, which is selected from at least one of the following elements: Zn, Si, Ti, V, Cr, Mn, Ni, Ge, Zr, Nb, Mo, Pd, Ag, Cd, Sb, Hf, Ta, W, 0, C, N, S, F, and P.

On the basis of the above technical solutions, further, the diffusion source of the HR grain boundary diffusion is at least one of HR metal, HR oxides, HR hydrogen fluorides, HR fluorides, HR hydrides, HR oxyfluorides, or HR-M alloy. The above diffusion source may be in the powder form, or may be made into a target material and deposited on the surface of the green body by vapor deposition, or may be in another form.

On the basis of the above technical solutions, further, the diffusion source is an HR-M alloy, wherein the content of M is 2 wt % or more and 30 wt % or less, and the content of the HR is 70 wt % or more and 98 wt % or less.

On the basis of the above technical solutions, further, the R—Fe—B sintered green body is a square green body.

Further disclosed in the present invention is an HR grain boundary diffusion treatment method of the R—Fe—B sintered magnet, wherein the R—Fe—B sintered magnet includes an orientation plane perpendicular to the magnetization direction and a non-orientation plane which is a surface other than the orientation plane; and an HR-containing diffusion source is applied to at least one non-orientation plane of the R—Fe—B sintered magnet so that grain boundary diffusion of HR is performed in a direction perpendicular to the magnetization direction of the R—Fe—B sintered magnet, and then heat treatment is performed.

On the basis of the above technical solutions, further, the R—Fe—B sintered green body is a square green body, and the HR-containing diffusion source is applied to four non-orientation planes of the R—Fe—B sintered green body.

On the basis of the above technical solutions, further, the preparation of the R—Fe—B sintered magnet includes at least the following steps: a process of melting raw material ingredients of the R—Fe—B sintered green body to obtain a rapid-quenched alloy; a process of performing hydrogen decrepitation and pulverization on the rapid-quenched alloy to obtain fine powder; and obtaining the R—Fe—B sintered green body by magnetic field compacting and sintering of the fine powder.

In the present invention, the smelting process in the preparation method is not particularly limited, and can be appropriately selected according to the purpose of those of skill in the art. For example, the formulated raw materials can be placed into a crucible made of alumina, and vacuum smelting is performed in a high-frequency vacuum induction smelting furnace under vacuum of 10⁻² Pa-10⁻³ Pa at a temperature 1500° C. or less.

The casting process in the preparation method is not particularly limited, and can be appropriately selected according to the purpose of those of skill in the art. For example, after the vacuum smelting, an Ar gas is introduced into the smelting furnace until the gas pressure reached 30,000-50,000 Pa, and then casting is performed using a single-roller rapid-quenching process at a cooling rate of 10²° C./sec-10⁴° C./sec to acquire a rapid-quenched alloy. The rapid-quenched alloy is subjected to a thermal insulation heat treatment at 500° C.-600° C. for 60 min-120 min, and then cooled to room temperature.

The hydrogen decrepitation process in the preparation method is not particularly limited, and can be appropriately selected according to the purpose of those of skill in the art. For example, a hydrogen decrepitation furnace in which the rapid-quenched alloy is placed is vacuumized at room temperature, and then hydrogen with a purity of 99.5% is introduced into the hydrogen decrepitation furnace to a pressure of 0.08 MPa-0.1 MPa. After full absorption of hydrogen, the furnace is vacuumized while raising the temperature therein, which is vacuumized at a temperature of 500° C.-650° C., and then is cooled down, thereby acquiring powder after the hydrogen decrepitation.

The pulverization process in the preparation method is not particularly limited, and can be appropriately selected according to the purpose of those of skill in the art. For example, in a nitrogen atmosphere with an oxidizing gas content of 100 ppm or less, the powder acquired after the hydrogen decrepitation is subjected to jet milling in a pulverizing chamber at a pressure of 0.38 MPa to 0.42 MPa for 100 min to 200 min to obtain fine powder, which can be graded by a grader as required. The oxidizing gas refers to oxygen or moisture.

The magnetic field compacting process in the preparation method is not particularly limited, and can be appropriately selected according to the purpose of those of skill in the art. For example, an organic additive is added into the fine powder after the decrepitation. The powder in which methyl caprylate had been added as described above is primarily shaped as a cube having a side length of 50mm using a right angle-oriented magnetic field compacting machine in an oriented magnetic field of 1.8 T at a compacting pressure of 0.4 ton/cm², and is demagnetized in a magnetic field of 0.2 T after the primary compacting. In order to prevent the shaped body acquired after the primary compacting from being in contact with air, the shaped body is sealed, and then subjected to a secondary compacting at a pressure of 1.4 ton/cm² using a secondary compacting machine (isostatic pressure compacting machine).

The sintering process in the preparation method is not particularly limited, and can be appropriately selected according to the purpose of those of skill in the art. For example, each shaped body is transferred to a sintering furnace and subjected to sintering under a vacuum of 10⁻³ Pa at the temperature of 200° C.-300° C. and 500° C.-800° C. each for 2 hours, followed by sintering at a temperature of 920° C.-1050° C. for 2 hours. Afterwards, an Ar gas is introduced until the gas pressure reached 0.1 MPa, and then the sintered body is cooled to room temperature.

The heat treatment process in the preparation method is not particularly limited, and can be appropriately selected according to the purpose of those of skill in the art. For example, after heat treatment is performed at a temperature of 460° C.-600° C. for 1-2 hours, the shaped body is cooled to room temperature and then acquired.

The method for applying the diffusion source in the preparation method is not particularly limited, and can be appropriately selected according to the purpose of those of skill in the art. For example, the manner of vapor deposition, or the manner of mixing powder with an organic solvent to prepare a slurry and coating on a surface, and the like are employed.

It should be noted that, the grain boundary diffusion is generally carried out at a temperature of 700° C. to 1050° C. This temperature range is a conventional option in the industry. Therefore, in the embodiments, the above temperature range is not tested and verified.

### Embodiment 1

Preparation process for raw material: Nd with a purity of 99.5%, industrial Fe—B, industrial pure Fe, Co and Zr with a purity of 99.9% and Al, Cu, Ga and Ti with a purity of 99.5% were prepared, which were formulated in mass percentage (wt %).

Smelting process: the formulated raw materials were placed into a crucible made of alumina and subjected to vacuum smelting in a high-frequency vacuum induction smelting furnace under a vacuum of 10⁻² Pa at a temperature of 1500° C.

Casting process: after the vacuum smelting, an Ar gas was introduced into the smelting furnace until the gas pressure reached 50,000 Pa, and then casting was performed using a single-roller rapid-quenching process at a cooling rate of 10²° C./sec to acquire a rapid-quenched alloy. The rapid-quenched alloy was subjected to a thermal insulation heat treatment at 600° C. for 60 minutes, and then cooled to room temperature.

Hydrogen decrepitation process: a hydrogen decrepitation furnace in which the rapid-quenched alloy was placed was vacuumized at room temperature, and then hydrogen with a purity of 99.5% was introduced into the hydrogen decrepitation furnace to a pressure of 0.1 MPa. After left for 2 hours, the furnace was vacuumized while raising the temperature therein, which was vacuumized at a temperature of 500° C. and then was cooled down, thereby acquiring powder after the hydrogen decrepitation.

Pulverization process: in a nitrogen atmosphere with an oxidizing gas content of 100 ppm or less, the powder acquired after the hydrogen decrepitation was subjected to jet milling in a pulverizing chamber at a pressure of 0.4 MPa for 2 hours, to obtain fine powder. The oxidizing gas refers to oxygen or moisture.

Part of the pulverized fine powder (accounting for 30% of the total weight of the fine powder) was graded by a grader, particles with a particle diameter of 1.0 μm or less were removed, and then the graded fine powder was mixed with the remaining ungraded fine powder. In the mixed fine powder, the volume of the powder with a particle diameter of 1.0 μm or less was reduced to 10% or less of the total volume of the powder.

Methyl caprylate was added into the powder acquired after the jet milling with an addition amount of 0.2% relative to the weight of the mixed powder, and then was well mixed with the powder using a V-type mixer.

Magnetic field compacting process: the powder in which methyl caprylate had been added as described above was primarily shaped as a cube having a side length of 50 mm using a right angle-oriented magnetic field compacting machine in an oriented magnetic field of 1.8 T at a compacting pressure of 0.4 ton/cm², and was demagnetized in a magnetic field of 0.2 T after the primary compacting.

In order to prevent the shaped body acquired after the primary compacting from being in contact with air, the shaped body was sealed, and then subjected to a secondary compacting at a pressure of 1.4 ton/cm² using a secondary compacting machine (isostatic pressure compacting machine).

Sintering process: each shaped body was transferred to a sintering furnace and subjected to sintering under a vacuum of 10⁻³ Pa at the temperature of 200° C. and 800° C. each for 2 hours, followed by sintering at a temperature of 1030° C. for 2 hours. Afterwards, an Ar gas was introduced until the gas pressure reached 0.1 MPa and then the sintered body was cooled to room temperature, to obtain a sintered magnetic green body.

Machining process: the sintered magnetic green body was processed, by internal circle machining or wire cut electric discharge machining, to a cuboid with a device size of 18 mm*39 mm*50 mm, of which 50 mm was the length of the magnetization direction.

Grain boundary diffusion treatment: four non-orientation surfaces of the processed sintered magnetic green body were all coated with powder of the Tb hydride diffusion source, and maintained for 10 h in a vacuum environment at a temperature of 850° C., so that grain boundary diffusion of Tb was performed in a direction perpendicular to the magnetization direction of the processed sintered magnetic green body.

Heat treatment process: the sintered magnetic green body was subjected to a heat treatment in a high-purity Ar gas at a temperature of 500° C. for 1 hour, cooled to room temperature and then taken out, to obtain the R—Fe—B sintered magnet subjected to Tb grain boundary diffusion treatment.

Post-treatment process: the R—Fe—B sintered magnet subjected to diffusion treatment was cut into several cuboids in the magnetization direction. The size of the final product processed was 18 mm*39 mm*1.8 mm, of which 1.8 mm was the length of the magnetization direction.

Embodiments 1.1 to 1.16 and Comparative examples 1.1 to 1.7 in Table 1 are all sintered green bodies prepared by the method of Embodiment 1, and subsequent grain boundary diffusion treatments; heat treatment processes and the amount of the diffusion source thereof were the same, the difference was only in that components of the raw materials used were different, and thus the components of the resulting sintered green bodies were different. The prepared sintered magnets were directly tested for the magnetic performance, to evaluate magnetic properties thereof. The components of the sintered green body of each embodiment and each comparative example are shown in Table 1. Evaluation results of the sintered magnets of each embodiment and each comparative example are shown in Table 2.

TABLE 1
Components (wt %) of sintered green bodies of Embodiments
1.1 to 1.16 and Comparative examples 1.1 to 1.7

| No. | Nd | B | Al | Ga | Cu | Ti | Co | Zr | O | Fe |
|---|---|---|---|---|---|---|---|---|---|---|
| Comparative | 30.5 | 1.00 | 0.08 | 0.3 | 0.12 | 0.1 | 0.8 | 0.1 | 0.1 | Balance |
| example 1.1 | | | | | | | | | | |
| Embodiment 1.1 | 30.5 | 0.96 | 0.08 | 0.3 | 0.12 | 0.1 | 0.8 | 0.1 | 0.1 | Balance |
| Embodiment 1.2 | 30.5 | 0.92 | 0.08 | 0.3 | 0.12 | 0.1 | 0.8 | 0.1 | 0.1 | Balance |
| Embodiment 1.3 | 30.5 | 0.88 | 0.08 | 0.3 | 0.12 | 0.1 | 0.8 | 0.1 | 0.1 | Balance |
| Embodiment 1.4 | 30.5 | 0.83 | 0.08 | 0.3 | 0.12 | 0.1 | 0.8 | 0.1 | 0.1 | Balance |
| Comparative | 30.5 | 0.8 | 0.08 | 0.3 | 0.12 | 0.1 | 0.8 | 0.1 | 0.1 | Balance |
| example 1.2 | | | | | | | | | | |
| Comparative | 30.5 | 0.92 | 0.08 | 0.08 | 0.12 | 0.1 | 0.8 | 0.1 | 0.1 | Balance |
| example 1.3 | | | | | | | | | | |
| Embodiment 1.5 | 30.5 | 0.92 | 0.08 | 0.1 | 0.12 | 0.1 | 0.8 | 0.1 | 0.1 | Balance |
| Embodiment 1.6 | 30.5 | 0.92 | 0.08 | 0.35 | 0.12 | 0.1 | 0.8 | 0.1 | 0.1 | Balance |
| Embodiment 1.7 | 30.5 | 0.92 | 0.08 | 0.4 | 0.12 | 0.1 | 0.8 | 0.1 | 0.1 | Balance |
| Embodiment 1.8 | 30.5 | 0.92 | 0.08 | 0.45 | 0.12 | 0.1 | 0.8 | 0.1 | 0.1 | Balance |
| Embodiment 1.9 | 30.5 | 0.92 | 0.08 | 1.0 | 0.12 | 0.1 | 0.8 | 0.1 | 0.1 | Balance |
| Comparative | 30.5 | 0.92 | 0.08 | 1.3 | 0.12 | 0.1 | 0.8 | 0.1 | 0.1 | Balance |
| example 1.4 | | | | | | | | | | |
| Comparative | 30.5 | 0.92 | 0.08 | 0.1 | 0.1 | 0.1 | 0.8 | 0.1 | 0.1 | Balance |
| example 1.5 | | | | | | | | | | |
| Comparative | 30.5 | 0.92 | 0.1 | 0.08 | 0.1 | 0.1 | 0.8 | 0.1 | 0.1 | Balance |
| example 1.6 | | | | | | | | | | |
| Embodiment 1.9 | 30.5 | 0.92 | 0.08 | 0.1 | 0.2 | 0.1 | 0.8 | 0.1 | 0.1 | Balance |
| Embodiment 1.10 | 30.5 | 0.92 | 0.08 | 0.2 | 0.1 | 0.1 | 0.8 | 0.1 | 0.1 | Balance |
| Embodiment 1.11 | 30.5 | 0.92 | 0.2 | 0.1 | 0.08 | 0.1 | 0.8 | 0.1 | 0.1 | Balance |
| Embodiment 1.12 | 30.5 | 0.92 | 0.08 | 0.2 | 0.2 | 0.1 | 0.8 | 0.1 | 0.1 | Balance |
| Embodiment 1.13 | 30.5 | 0.92 | 0.08 | 0.3 | 0.3 | 0.1 | 0.8 | 0.1 | 0.1 | Balance |
| Embodiment 1.14 | 30.5 | 0.92 | 0.3 | 0 | 0 | 0.1 | 0.8 | 0.1 | 0.1 | Balance |
| Embodiment 1.15 | 30.5 | 0.92 | 0 | 0.3 | 0 | 0.1 | 0.8 | 0.1 | 0.1 | Balance |
| Embodiment 1.16 | 30.5 | 0.92 | 0.3 | 0.3 | 0.2 | 0.1 | 0.8 | 0.1 | 0.1 | Balance |
| Comparative | 30.5 | 0.92 | 0.1 | 0.1 | 0.08 | 0.1 | 0.8 | 0.1 | 0.1 | Balance |
| example 1.7 | | | | | | | | | | |

TABLE 2
Performance evaluation of sintered magnets of Embodiments 1.1 to 1.16 and Comparative examples 1.1 to 1.7

| | | | | | | | | | 120° C. Open |
|---|---|---|---|---|---|---|---|---|---|
| | | | | | | | | | circuit thermal |
| | HRₐ | HR_{b} | HR_{c} | HR_{d} | | HRₑ | HR_{f} | HR_{g} | demagnetization |
| No. | (wt %) | (wt %) | (wt %) | (wt %) | HR_{d}/HRₐ | (wt %) | (wt %) | (wt %) | rate (%) |
| Comparative | 12.5 | 0.43 | 0.31 | 0.26 | 0.021 | 0.47 | 0.59 | 0.31 | 15 |
| example 1.1 | | | | | | | | | |
| Embodiment 1.1 | 8.58 | 4.97 | 2.25 | 0.86 | 0.100 | 4.65 | 4.73 | 5.01 | 2.7 |
| Embodiment 1.2 | 8.24 | 6.89 | 3.79 | 1.05 | 0.127 | 5.87 | 5.92 | 5.49 | 1.1 |
| Embodiment 1.3 | 8.45 | 6.91 | 4.05 | 1.23 | 0.145 | 6.33 | 5.97 | 6.09 | 1.5 |
| Embodiment 1.4 | 8.33 | 5.93 | 3.95 | 1.17 | 0.140 | 5.65 | 5.37 | 5.89 | 1.7 |
| Comparative | 9.33 | 5.95 | 2.09 | 1.12 | 0.120 | 5.77 | 5.69 | 5.95 | 12.9 |
| example 1.2 | | | | | | | | | |
| Comparative | 17.5 | 0.47 | 0.33 | 0.27 | 0.015 | 0.35 | 0.69 | 0.73 | 23 |
| example 1.3 | | | | | | | | | |
| Embodiment 1.4 | 8.33 | 5.93 | 3.95 | 1.17 | 0.140 | 5.88 | 5.67 | 5.97 | 1.7 |
| Embodiment 1.5 | 8.36 | 4.87 | 2.34 | 0.97 | 0.116 | 5.38 | 5.49 | 5.54 | 1.3 |
| Embodiment 1.6 | 8.22 | 6.01 | 4.33 | 1.56 | 0.189 | 5.96 | 6.03 | 6.14 | 2.1 |
| Embodiment 1.7 | 8.29 | 5.97 | 4.59 | 2.01 | 0.242 | 5.39 | 5.63 | 5.78 | 1.9 |
| Embodiment 1.8 | 8.33 | 6.05 | 4.77 | 2.31 | 0.277 | 4.97 | 5.09 | 5.13 | 2.3 |
| Embodiment 1.9 | 8.45 | 5.33 | 3.65 | 1.48 | 0.175 | 5.45 | 5.67 | 5.39 | 3.1 |
| Comparative | 8.54 | 5.99 | 4.29 | 1.38 | 0.162 | 5.87 | 5.79 | 5.65 | 11 |
| example 1.4 | | | | | | | | | |
| Comparative | 16.2 | 0.85 | 0.37 | 0.22 | 0.014 | 0.97 | 0.33 | 0.85 | 13 |
| example 1.5 | | | | | | | | | |
| Comparative | 19.1 | 0.79 | 0.42 | 0.37 | 0.019 | 0.69 | 0.57 | 0.31 | 17 |
| example 1.6 | | | | | | | | | |
| Embodiment 1.10 | 8.98 | 5.99 | 3.49 | 1.57 | 0.175 | 5.46 | 5.31 | 5.72 | 2.4 |
| Embodiment 1.11 | 8.93 | 5.94 | 3.77 | 1.65 | 0.185 | 5.83 | 5.61 | 5.79 | 2.1 |
| Embodiment 1.12 | 9.44 | 6.98 | 4.79 | 2.39 | 0.253 | 6.43 | 6.29 | 6.15 | 1.6 |
| Embodiment 1.13 | 8.38 | 6.95 | 4.67 | 2.45 | 0.292 | 4.19 | 4.27 | 4.23 | 1.9 |
| Embodiment 1.14 | 8.89 | 5.25 | 3.17 | 1.32 | 0.148 | 5.12 | 4.98 | 5.37 | 2.6 |
| Embodiment 1.15 | 9.32 | 5.33 | 3.48 | 1.42 | 0.152 | 5.29 | 5.35 | 5.61 | 2.9 |
| Embodiment 1.16 | 8.63 | 6.79 | 5.05 | 2.79 | 0.323 | 6.22 | 5.98 | 6.31 | 1.7 |
| Comparative | 15.3 | 1.44 | 0.78 | 0.33 | 0.022 | 1.13 | 0.71 | 1.58 | 17 |
| example 1.7 | | | | | | | | | |

It can be seen from Tables 1 to 2, in comparison of Embodiments 1.1 to 1.4 and Comparative example 1.1, as the content of the element B of Comparative example 1.1 was higher than 0.96 wt %, a sufficient amount of metastable phase could not be formed and the HR diffusion in a direction perpendicular to the magnetization direction was inhibited, so the magnet performance was degraded significantly, and the thermal demagnetization resistance was seriously insufficient. Compared with Embodiments 1.1 to 1.4, in Comparative example 1.2 although the content of the element B was low and the diffusion effect of HR was also improved, a phenomenon of segregation of the 2-17 soft magnetic phase occurred, causing the thermal demagnetization resistance to degrade. Therefore, the content of the element B needs to be controlled within a reasonable range, in order to improve the thermal demagnetization resistance while increasing the HR diffusion in a direction perpendicular to the magnetization direction.

In Comparative examples 1.3, 1.5, 1.6, and 1.7, the sum of three elements of Al, Ga and Cu, i.e., the content of M, was less than 0.3 wt %. Because the content of M was too low, the conventional grain boundary rare earth-rich phase could not facilitate the non-orientated diffusion of HR. In Comparative example 1.4, the sum of three elements of Al, Ga, and Cu, i.e., the content of M, exceeded 1.2 wt %. The excessive element M would enter the 2-14-1 main phase, causing deterioration of the magnet performance. Therefore, for the element M, when the content thereof is controlled to be within 0.3 wt %-1.2 wt %, the non-oriented diffusion effect can be enhanced, and the thermal demagnetization resistance of the sintered magnet can be significantly improved.

### Embodiment 2

Preparation process for raw material: Nd with a purity of 99.5%, industrial Fe—B, industrial pure

Fe, Co and Zr with a purity of 99.9% and Al, Cu, Ga and Ti with a purity of 99.5% were prepared, which were formulated in mass percentage (wt %).

Smelting process: the formulated raw materials were placed into a crucible made of alumina and subjected to vacuum smelting in a high-frequency vacuum induction smelting furnace under a vacuum of 10⁻³ Pa at a temperature of 1450° C.

Casting process: after the vacuum smelting, an Ar gas was introduced into the smelting furnace until the gas pressure reached 30,000 Pa, and then casting was performed using a single-roller rapid-quenching process at a cooling rate of 10⁴° C./sec to acquire a rapid-quenched alloy. The rapid-quenched alloy was subjected to a thermal insulation heat treatment at 500° C. for 120 minutes, and then cooled to room temperature.

Hydrogen decrepitation process: a hydrogen decrepitation furnace in which the rapid-quenched alloy was placed was vacuumized at room temperature, and then hydrogen with a purity of 99.5% was introduced into the hydrogen decrepitation furnace to a pressure of 0.08 MPa. After left for 2 hours, the furnace was vacuumized while raising the temperature therein, which was vacuumized at a temperature of 650° C. and then was cooled down, thereby acquiring powder after the hydrogen decrepitation.

Pulverization process: in a nitrogen atmosphere with an oxidizing gas content of 100 ppm or less, the powder acquired after the hydrogen decrepitation was subjected to jet milling in a pulverizing chamber at a pressure of 0.42 MPa for 100 min, to obtain fine powder.

Zinc stearate was added to the jet mill pulverized powder; the amount of the zinc stearate added was 0.2% of the weight of the mixed powder, and the mixture was then fully mixed using a V-type mixer.

Magnetic field compacting process: the powder in which zinc stearate had been added as described above was primarily shaped as a cube having a side length of 50 mm using a right angle-oriented magnetic field compacting machine in an oriented magnetic field of 1.8 T at a compacting pressure of 0.4 ton/cm², and was demagnetized in a magnetic field of 0.2 T after the primary compacting.

In order to prevent the shaped body acquired after the primary compacting from being in contact with air, the shaped body was sealed, and then subjected to a secondary compacting at a pressure of 1.4 ton/cm² using a secondary compacting machine (isostatic pressure compacting machine).

Sintering process: each shaped body was transferred to a sintering furnace and subjected to sintering under a vacuum of 10⁻³ Pa at the temperature of 300° C. and 600° C. each for 2 hours, followed by sintering at a temperature of 920° C. for 2 hours. Afterwards, an Ar gas was introduced until the gas pressure reached 0.1 MPa and then the sintered body was cooled to room temperature, to obtain a sintered magnetic green body.

Processing process: the sintered magnetic green body was processed, by internal circle machining or wire cut electric discharge machining, to a cuboid with a device size of 18 mm*39 mm*50 mm, of which 50 mm was the thickness of the orientation direction.

Grain boundary diffusion treatment: four non-orientation planes of the processed sintered magnetic green body were applied with a Tb-containing diffusion source and maintained for 8 h in a vacuum or Ar atmosphere environment at a temperature of 880° C., so that grain boundary diffusion of Tb was performed in a direction perpendicular to the magnetization direction of the processed sintered magnetic green body. Manner of applying a diffusion source: the Tb-containing diffusion source was an alloy target, deposition was performed on a non-orientation surface by means of physical vapor deposition and a Tb-containing thin film was formed.

Heat treatment process: the sintered magnetic green body was subjected to a heat treatment in a high-purity Ar gas at a temperature of 600° C. for 1 hour, cooled to room temperature and then taken out, to obtain the R—Fe—B sintered magnet subjected to Tb grain boundary diffusion treatment.

Post-treatment process: the R—Fe—B sintered magnet subjected to diffusion treatment was cut into several cuboids in the magnetization direction. The size of the final product processed was 18 mm*39 mm*1.8 mm, of which 1.8 mm was the thickness of the orientation direction.

Each embodiment in Table 3 adopted the method of Embodiment 2 to prepare the sintered green body and had the same components. The difference was only in that, the diffusion source used during the grain boundary diffusion was different, but the total content of the element Tb in various diffusion sources was the same. In Embodiment 2.4, the content of M was 25 wt %, and the content of HR was 75 wt %. The components of the sintered green body of each embodiment are shown in Table 3. Evaluation results of the sintered magnets of Embodiments 2.1 to 2.4 are shown in Table 4.

TABLE 3
Components (wt %) of sintered green
bodies of Embodiments 2.1 to 2.4

| Element | Nd | B | Al | Ga | Cu | Ti | Co | Zr | Fe |
|---|---|---|---|---|---|---|---|---|---|
| Sintered | 30.5 | 0.92 | 0.08 | 0.2 | 0.12 | 0.1 | 0.8 | 0.1 | Balance |
| magnet | | | | | | | | | |

TABLE 4
Performance evaluation of sintered magnets of Embodiments 2.1 to 2.4

| | | | | | | | 120° C. Open |
|---|---|---|---|---|---|---|---|
| | | | | | | | circuit thermal |
| | Diffusion | HRₐ | HR_{b} | HR_{c} | HR_{d} | | demagnetization |
| No. | source | (wt %) | (wt %) | (wt %) | (wt %) | HR_{d}/HRₐ | rate (%) |
| Embodiment 2.1 | Tb metal | 18.5 | 10.61 | 6.53 | 4.37 | 0.236 | 3.9 |
| Embodiment 2.1 | Tb oxide | 23.7 | 15.87 | 10.57 | 6.41 | 0.270 | 3.6 |
| Embodiment 2.1 | Tb fluoride | 14.2 | 9.71 | 7.49 | 3.33 | 0.235 | 3.9 |
| Embodiment 2.1 | Tb—Al alloy | 9.33 | 7.05 | 5.79 | 3.29 | 0.353 | 2.2 |

It was found through observation that, in the sintered magnet of Embodiment 2.4, the effect of HR diffusion in a direction perpendicular to the magnetization direction on the sintered magnet was significantly enhanced, and the thermal demagnetization resistance of the magnet was greatly improved. This is because the element M in the HR-M alloy had an effective auxiliary effect on the diffusion of the HR element from the magnet surface to the inside in a direction perpendicular to the magnetization direction, and effectively solved the problem of anisotropy of grain boundary diffusion of heavy rare earth.

### Embodiment 3

The preparation method of the sintered body in this embodiment was the same as that of Embodiment 2.4, i.e., during the grain boundary diffusion, an HR-M alloy was used as the diffusion source. The difference among the following embodiments was only in that, the HR content and the M content in the HR-M alloy were different and only one non-orientation plane Al was applied with the diffusion source, and the total content of the element Tb in each diffusion was the same. Components of the diffusion source of each embodiment are shown in Table 5. Evaluation results of the sintered magnets of Embodiments 3.1 to 3.6 are shown in Table 6.

TABLE 5
Components (wt %) of diffusion sources
of Embodiments 3.1 to 3.6

| No. | Tb | Al | Cu | Ga |
|---|---|---|---|---|
| Embodiment 3.1 | 98.5 | 0.5 | 0.5 | 0.5 |
| Embodiment 3.2 | 95 | 5 | 0 | 0 |
| Embodiment 3.3 | 95 | 0 | 5 | 0 |
| Embodiment 3.4 | 95 | 0 | 0 | 5 |
| Embodiment 3.5 | 70 | 10 | 10 | 10 |
| Embodiment 3.6 | 50 | 20 | 15 | 15 |

TABLE 6
Performance evaluation of sintered magnets of Embodiments 3.1 to 3.6

| | | | | | | 120° C. Open |
|---|---|---|---|---|---|---|
| | | | | | | circuit thermal |
| | HRₐ | HR_{b} | HR_{c} | HR_{d} | | demagnetization |
| No. | (wt %) | (wt %) | (wt %) | (wt %) | HR_{d}/HRₐ | rate (%) |
| Embodiment 3.1 | 19.6 | 12.31 | 8.98 | 4.57 | 0.233 | 3.5 |
| Embodiment 3.2 | 9.37 | 6.35 | 4.79 | 2.97 | 0.317 | 2.8 |
| Embodiment 3.3 | 8.97 | 5.87 | 4.33 | 2.83 | 0.315 | 2.3 |
| Embodiment 3.4 | 8.33 | 5.12 | 3.77 | 2.56 | 0.307 | 1.9 |
| Embodiment 3.5 | 9.12 | 6.55 | 4.87 | 3.32 | 0.364 | 1.7 |
| Embodiment 3.6 | 6.33 | 3.76 | 1.55 | 1.33 | 0.210 | 9.7 |

It has been shown from Embodiment 2 that, M had an effective auxiliary effect on the diffusion of the HR element from the surface to the inside in the direction perpendicular to the magnetization direction. Combining the above with Table 5 and Table 6, it can be found that, the diffusion source of Embodiment 3.1 only had a small amount of the element M increased. Therefore, compared with Embodiment 2.1, the effect thereof of HR diffusion in a direction perpendicular to the magnetization direction in the sintered magnet was only slightly improved. The content of M in Embodiments 3.2 to 3.5 was appropriate, and the effect of Tb diffusion in the direction perpendicular to the magnetization direction was improved more significantly. However, in

Embodiment 3.6, as the content of M was too high, the HR concentration was seriously diluted and a large amount of the element M would enter the inside of the main phase grains, so that the intrinsic magnetic performance of the main phase grains was reduced, and the thermal demagnetization resistance was decreased.

The above embodiments are only used to explain the technical solutions provided by the present invention, and should not limit the present invention. Any simple amendments, equivalent changes and modifications made to the above embodiments based on the technical essence of the present invention shall all fal into the protection scope of the technical solutions of the present invention.

1. An R—Fe—B sintered magnet, wherein the R—Fe—B sintered magnet is obtained by performing HR grain boundary diffusion treatment on an R—Fe—B sintered green body comprising an R₂Fe₁₄B-type main phase and comprising at least the following ingredients:
28 wt %-33 wt % of R, which is at least one rare earth element comprising Nd;
0.83 wt %-0.96 wt % of B;
0.3 wt %-1.2 wt % of M, which is selected from at least one of Al, Cu, Ga, Bi, Sn, Pb, and In; and
65.2 wt %-70.5 wt % of Fe, or Fe and Co; wherein
the HR is selected from at least one of Dy, Tb, Ho, Er, Tm, Y, Yb, Lu, and Gd;
the R—Fe—B sintered green body has a magnetization direction and several surfaces, wherein a surface perpendicular to the magnetization direction is an orientation plane, and a surface other than the orientation plane is a non-orientation plane; and an HR-containing diffusion source is applied to at least one non-orientation plane of the R—Fe—B sintered green body so that grain boundary diffusion of HR is performed in a direction perpendicular to the magnetization direction of the R—Fe—B sintered green body, and the non-orientation plane to which the HR-containing diffusion source is applied is a diffusion plane; and
in a diffusion direction, a point has an HR content that increases with a smaller distance from the diffusion plane, and a ratio of HR contents of any two points spaced from the diffusion plane by a distance of no more than 500 μm is 0.1-1.0.

2. The R—Fe—B sintered magnet according to claim 1, wherein, in the diffusion direction, the ratio of HR contents of any two points spaced from the diffusion plane by a distance of no more than 500 μm is 0.2-1.0.

3. The R—Fe—B sintered magnet according to claim 1, wherein, in the magnetization direction, the ratio of HR contents of any two points is 0.7-1.0.

4. The R—Fe—B sintered magnet according to claim 1, wherein the R—Fe—B sintered green body further comprises 0.05 wt %-2.5 wt % of T, which is selected from at least one of the following elements: Zn, Si, Ti, V, Cr, Mn, Ni, Ge, Zr, Nb, Mo, Pd, Ag, Cd, Sb, Hf, Ta, W, O, C, N, S, F, and P.

5. The R—Fe—B sintered magnet according to claim 1, wherein the M is selected from at least one of Ga, Al, and Cu, and a sum of contents of the Ga, Al, and Cu is 0.3 wt %-0.8 wt %.

6. The R—Fe—B sintered magnet according to claim 1, wherein the HR-containing diffusion source of the HR grain boundary diffusion is at least one of HR metal, HR oxides, HR hydrogen fluorides, HR fluorides, HR hydrides, HR oxyfluorides, and HR-M alloy.

7. The R—Fe—B sintered magnet according to claim 6, wherein, in the HR-containing diffusion source of an HR-M alloy, a content of the M is 2 wt % or more and 30 wt % or less, and a content of the HR is 70 wt % or more and 98 wt % or less.

8. The R—Fe—B sintered magnet according to any of claim 1, wherein the R—Fe—B sintered green body is a square green body.

9. An HR grain boundary diffusion treatment method of the R—Fe—B sintered magnet according to claim 1, comprising:
performing heat treatment after the grain boundary diffusion of HR is performed in the direction perpendicular to the magnetization direction of the R—Fe—B sintered green body.

10. The HR grain boundary diffusion treatment method of the R—Fe—B sintered magnet according claim 9, wherein the R—Fe—B sintered green body is a square green body, and the HR-containing diffusion source is applied to four non-orientation surfaces of the R—Fe—B sintered green body.

11. The R—Fe—B sintered magnet according to any of claim 2, wherein the R—Fe—B sintered green body is a square green body.

12. The R—Fe—B sintered magnet according to any of claim 3, wherein the R—Fe—B sintered green body is a square green body.

13. The R—Fe—B sintered magnet according to any of claim 4, wherein the R—Fe—B sintered green body is a square green body.

14. The R—Fe—B sintered magnet according to any of claim 5, wherein the R—Fe—B sintered green body is a square green body.

15. The R—Fe—B sintered magnet according to any of claim 6, wherein the R—Fe—B sintered green body is a square green body.

16. The R—Fe—B sintered magnet according to any of claim 7, wherein the R—Fe—B sintered green body is a square green body.

17. An HR grain boundary diffusion treatment method of the R—Fe—B sintered magnet according to claim 2, comprising: performing heat treatment after the grain boundary diffusion of HR is performed in the direction perpendicular to the magnetization direction of the R—Fe—B sintered green body.

18. An HR grain boundary diffusion treatment method of the R—Fe—B sintered magnet according to claim 3, comprising: performing heat treatment after the grain boundary diffusion of HR is performed in the direction perpendicular to the magnetization direction of the R—Fe—B sintered green body.

19. An HR grain boundary diffusion treatment method of the R—Fe—B sintered magnet according to claim 4, comprising: performing heat treatment after the grain boundary diffusion of HR is performed in the direction perpendicular to the magnetization direction of the R—Fe—B sintered green body.

20. An HR grain boundary diffusion treatment method of the R—Fe—B sintered magnet according to claim 5, comprising: performing heat treatment after the grain boundary diffusion of HR is performed in the direction perpendicular to the magnetization direction of the R—Fe—B sintered green body.
